(19) United States
(12) Patent Application Publication
(10) Pub. No.: US 2011/0019140 A1
(43) Pub. Date: Jan. 27, 2011

(54) LIQUID CRYSTAL DISPLAY AND MANUFACTURING METHOD THEREOF

(75) Inventors: Jae-Hoon Kim, Cheonan-si (KR); Seong-Gyu Kwon, Suwon-si (KR); Yi-Seop Shim, Suwon-si (KR); Tae-Gee Min, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/580,408

(22) Filed: Oct. 16, 2009

(30) Foreign Application Priority Data
Jul. 22, 2009 (KR) 10-2009-0067049

(51) Int. Cl. G02F 1/1333; H01J 9/24

(52) U.S. Cl. 349/138; 445/24

(57) ABSTRACT

A display panel according to the present invention includes a first insulating substrate with a gate line and a data line formed thereon. A thin film transistor is connected to the gate line and the data line and a partition is formed according to the gate line and the data line defining a color filter filling region. Color filter is formed as a convex shape since both circumferences of upper portion and lower portion of the partition are larger than that of center portion. A color filter is formed in the filling region. A passivation layer is formed on the color filter and the partition and a pixel electrode on the passivation layer connected to the thin film transistor through a contact hole punching the passivation layer and the color filter.

### CROSS REFERENCE TO RELATED APPLICATION

This application claims priority from and the benefit of Korean Patent Application No. 10-2009-0067049 filed on Jul. 22, 2009, which is hereby incorporated by reference for all purposes as if fully set forth herein.

### BACKGROUND OF THE INVENTION

(a) Field of the Invention

The present invention relates to a display panel for a liquid crystal display, a liquid crystal display, and a manufacturing method thereof.

(b) Description of the Related Art

Generally, a liquid crystal display includes a pair of display panels provided with field generating electrodes and polarizers, and a liquid crystal layer interposed between the two is display panels. The field generating electrodes generate an electric field to the liquid crystal layer, and the arrangement of the liquid crystal molecules is changed according to the change of the intensity of the electric field. For example, the arrangement of the liquid crystal molecules of the liquid crystal layer is changed while applying the electric field such that the polarization of the light passing through the liquid crystal layer is changed. The polarizers appropriately block or transmit the polarized light to form bright and dark regions, thereby displaying images.

Color filters of three primary colors such as red, green, and blue are formed on one display panel of a liquid crystal display, and the manufacturing cost can be decreased when forming the color filters by using inkjet printing rather than photolithography process.

To form the color filters by using Inkjet printing, inks of desired amounts of three primary colors such as red, green, and blue are jetted through a plurality of nozzles of an Inkjet head, and the jetted inks are filled in regions enclosed by a light blocking member on a substrate.

When using the Inkjet printing system to form the color filters, repellant power of the ink against the surface of the light blocking member surface is generated such that the color filter is largely formed in the central portion of the region enclosed by the light blocking member as opposed to the edge of the region, and thereby the color filter may have a dome shape. Color filters with the dome shape may generate color hue at the edge of pixel areas.

### SUMMARY OF THE INVENTION

Accordingly, the present invention has been made in an effort to provide an liquid crystal display, a panel therefor, and a manufacturing method thereof having advantages of preventing color hue phenomenon at the pixel edge.

A thin film transistor with color filter array panel for a liquid crystal display is according to an exemplary embodiment of the present invention includes a substrate and a partition formed on the substrate defining a plurality of openings. A plurality of color filters are formed in the openings. A spacer is formed on the partition and the color filters and the spacer are formed through Inkjet printing.

The partition is a light blocking member. Both circumferences of upper portion and lower portion are larger than that of center portion. The partition may be formed on the first insulating substrate and the color filter may be formed on the first insulating substrate.

A display panel is made of two insulating substrate. A first insulating is facing

to the second insulating substrate, a liquid crystal layer interposed therebetween. A spacer between the first and the second substrate is formed with the partition in the same process step.

In the display panel, an upper passivation layer is formed on the color filter. A pixel electrode is formed on the upper passivation then. However, the upper passivation layer is formed to the thickness higher than the highest position of the color filter to planarize the surface. On the other hand, a lower passivation layer is formed on the thin film transistor, the gate line and data line.

### BRIEF DESCRIPTION OF THE DRAWINGS

FIG. 1 is an equivalent circuit diagram of one pixel in a liquid crystal display according to an exemplary embodiment of the present invention.

FIG. 2 is a layout view of a liquid crystal display according to an exemplary embodiment of the present invention.

FIG. 3 is a cross-sectional view of the liquid crystal display shown in FIG. 2 taken is along the line III-III.

FIG. 4 is a layout view of thin film transistor with color filter array panel of a liquid crystal display shown in FIG. 2 except a pixel electrode according to an exemplary embodiment of the present invention.

FIG. 5 is a pixel electrode of a liquid crystal display according to an exemplary embodiment of the present invention.

FIG. 6 is a cross-sectional view of color filter and light blocking member of a pixel on a liquid crystal display according to an exemplary embodiment of the present invention.

FIG. 7 is a cross-sectional view of color filter and light blocking member of a pixel on a liquid crystal display according to another exemplary embodiment of the present invention.

FIG. 8 is a top plan view of a basic electrode for the pixel electrode according to an exemplary embodiment of the present invention.

FIG. 9 to FIG. 14 are cross-sectional views sequentially showing manufacturing process of the thin film transistor with color filter panel of a liquid crystal display according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown.

As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

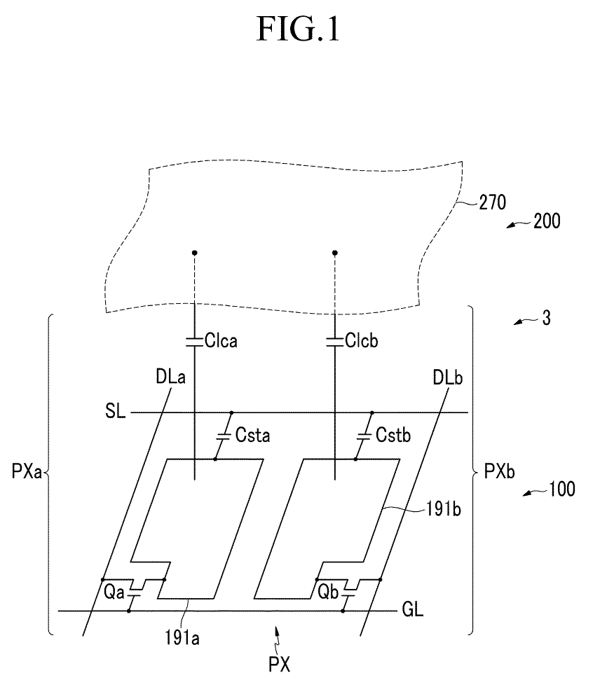

A thin film transistor with color filter array panel for a liquid crystal display and a liquid crystal display including the same according to an exemplary embodiment of the present invention will be described with reference to FIG. 1 to FIG. 3.

FIG. 1 is an equivalent circuit diagram of one pixel in a liquid crystal display according to an exemplary embodiment of the present invention.

Referring to FIG. 1, a liquid crystal display according to an exemplary embodiment of the present invention includes signal lines including a plurality of gate lines GL, a plurality of pairs of data lines DLa and DLb, a plurality of storage electrode lines SL, and a plurality of pixels PX connected to the signal lines. In the point of view of a structure, the liquid crystal display includes a lower panel 100 and an upper panel 200 facing each other, and a liquid crystal layer 3 interposed therebetween.

Each pixel PX includes a pair of subpixels PXa and PXb. Each subpixel PXa/PXb includes a switching element Qa/Qb, a liquid crystal capacitor Clca/Clcb, and a storage capacitor Csta/Cstb.

Each switching element Qa/Qb is a three-terminal element such as a thin film transistor provided on the lower panel 100, having a control terminal connected to the gate line GL, an input terminal connected to the data line DLa/DLb, and an output terminal connected to is the liquid crystal capacitor Clca/Clcb and the storage capacitor Csta/Cstb.

The liquid crystal capacitor Clca/Clcb uses a subpixel electrode and a common electrode 270 as two terminals. The liquid crystal layer 3 between electrodes 191a/191b and 270 functions as a dielectric material.

The storage capacitor Csta/Cstb serving as an assistant to the liquid crystal capacitor Clca/Clcb is formed as a storage electrode line SL provided on the lower display panel 100 and a subpixel electrode 191a/191b overlap with an insulator interposed therebetween, and a predetermined voltage such as the common voltage Vcom is applied thereto.

It has been determined that a predetermined difference is generated between voltages charged to two liquid crystal capacitors Clca and Clcb. For example, the data voltage applied to the liquid crystal capacitor Clca is less or more than the data voltage applied to the liquid crystal capacitor Clcb. Therefore, when the voltages of the first and second liquid crystal capacitors Clca and Clcb are appropriately adjusted, it is possible to make an image viewed from the side be as similar as possible to an image viewed from the front, and as a result it is possible to improve the side visibility.

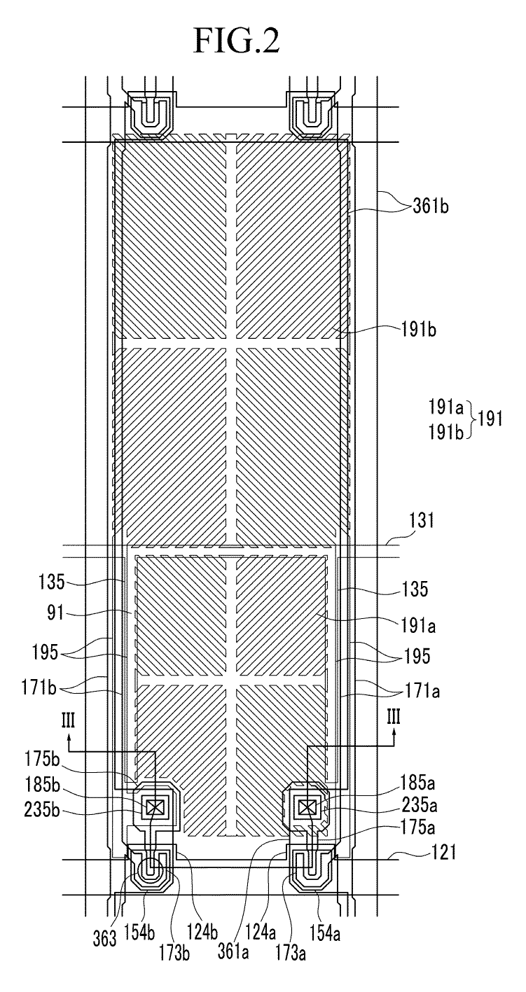

Next, a liquid crystal display according to an exemplary embodiment of the present invention will be described in detail with reference to FIG. 2 to FIG. 5.

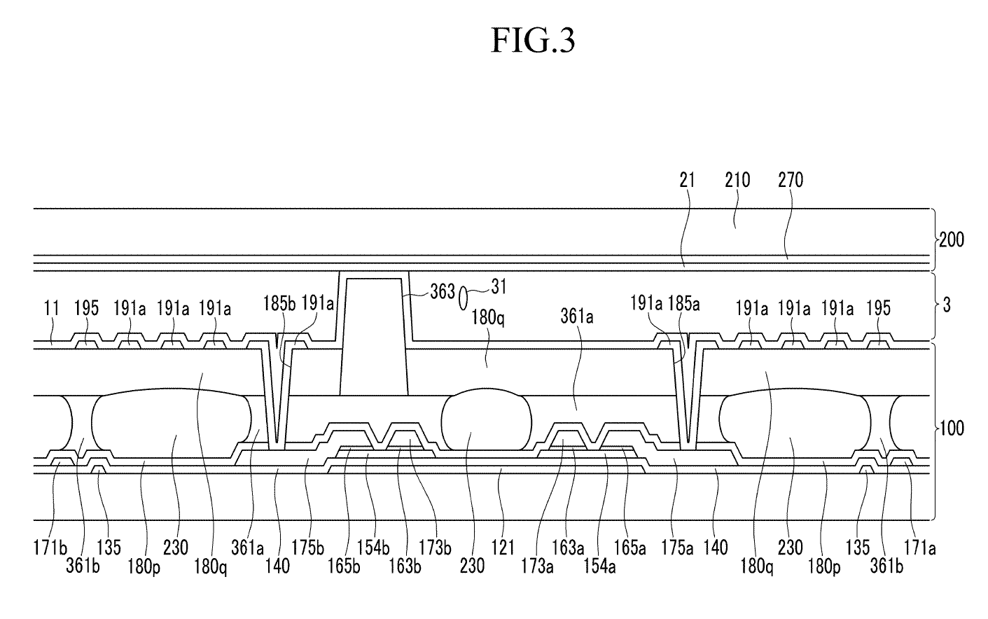

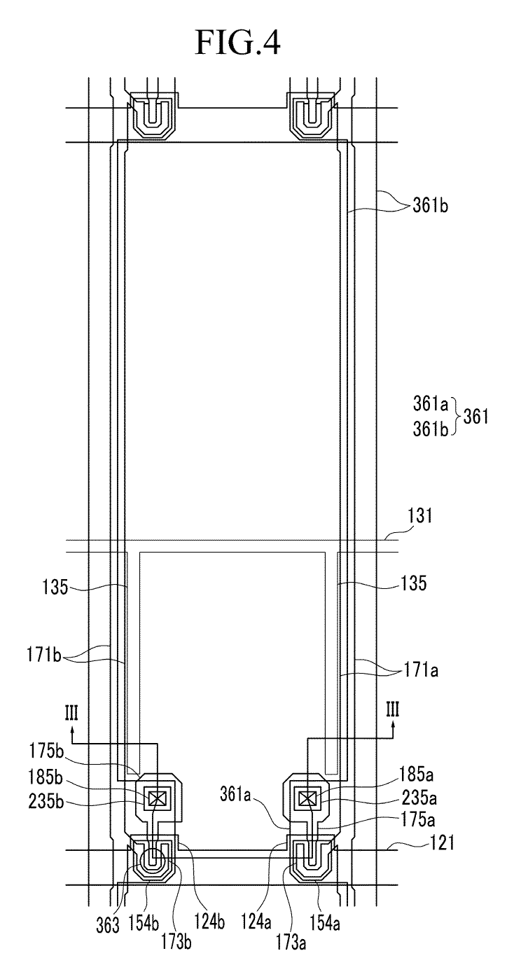

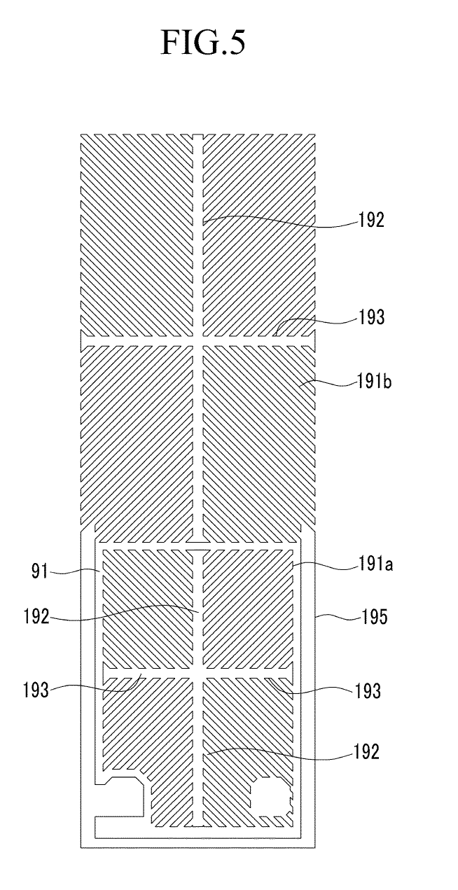

FIG. 2 is a layout view of a liquid crystal display according to an exemplary embodiment of the present invention, FIG. 3 is a cross-sectional view of the liquid crystal display shown in FIG. 2 taken along the line III-III, FIG. 4 is a layout view of thin film transistor with color filter array panel of a liquid crystal display shown in FIG. 2 except a pixel electrode according to an exemplary embodiment of the present invention, and FIG. 5 is a pixel electrode of a liquid crystal display according to an exemplary embodiment of the present invention.

Referring to FIG. 2 and FIG. 3, a liquid crystal display according to an exemplary embodiment of the present invention includes the lower panel 100 and the upper panel 200 facing to each other, and the liquid crystal layer 31 interposed between two display panels 100 and 200.

Firstly, the lower panel 100 will be described.

A plurality of gate lines 121 and a plurality of storage electrode lines 131 and 135 are formed on an insulating substrate 110. The gate lines 121 transmit gate signals and substantially extend in the transverse direction. Each gate line 121 includes a plurality of first and second gate electrodes 124a and 124b protruding upward. The storage electrode lines 131 include a stem extending substantially parallel to the gate lines 121, and a plurality of storage electrodes 135 extended from the stem. However, the shapes and arrangement of the storage electrode lines 131 and 135 may be modified in various forms.

A gate insulating layer 140 is formed on the gate lines 121 and the storage electrode lines 131 and 135, and a plurality of semiconductors 154a and 154b preferably made of amorphous or crystallized silicon are formed on the gate insulating layer 140.

A pair of a plurality of ohmic contacts 161a, 161b, 163a, 163b, 165a, and 165b are formed on the first semiconductors 154a and 154b, and the ohmic contacts 161a, 161b, 163a, 163b, 165a, and 165b may be formed of a material such as n+hydrogenated amorphous silicon in which an n-type impurity is doped with a high concentration, or of silicide.

A plurality of a pair of data lines 171a and 171b and a plurality of first and second drain electrodes 175a and 175b are formed on the ohmic contacts 161a, 161b, 163a, 163b, 165a, and 165b, and on the gate insulating layer 140. The data lines 171a and 171b transmit data signals, extend substantially in the longitudinal direction, and cross the gate lines 121 and the is stem of the storage electrode lines 131. Each data line 171a/171b includes a plurality of first/second source electrodes 173a/173b extending toward the first/second gate electrodes 124a/124b and curved with a “U” shape, and the first/second source electrodes 173a/173b are opposite to the first/second drain electrodes 175a/175b with respect to the first/second gate electrodes 124a/124b.

Each of the first and second drain electrodes 175a and 175b starts from one end enclosed by the first source electrode 173a, and extends upward, and the other end of the first and second drain electrodes 175a and 175b may have a wide area for connection with another layer. However, the shapes and arrangement of the first and second drain electrodes 175a and 175b and the data lines 171a and 171b may be modified in various forms.

A first/second gate electrode 124a/124b, a first/second source electrode 173a/173b, and a first/second drain electrode 175a/175b respectively form a first/second thin film transistor (TFT) Qa/Qb along with a first/second semiconductor 154a/154b, and a channel of the first/second thin film transistor Qa/Qb is formed on the first/second semiconductor 154a/154b between the first/second source electrode 173a/173b and the first/second drain electrode 175a/175b.

The ohmic contacts 163b and 165b are interposed only between the underlying semiconductor islands 154a and 154b, and the overlying data lines 171a and 171b and drain electrodes 175a and 175b, and reduce contact resistance between them. The semiconductors 154a and 154b have a portion that is exposed without being covered by the data lines 171a and 171b and the drain electrodes 175a and 175b, and a portion between the source electrodes 173a and 173b and the drain electrodes 175a and 175b.

The ohmic contacts 161a, 161b, 163a, 163b, 165a, and 165b, and the data lines is 171a, 171b, 173a, and 173b and the drain electrodes 175a and 175b have the same plane shape, and have substantially the same plane shape as the semiconductors 154a and 154b except for the exposed portion between the drain electrodes 175a and 175b, and the source electrodes 173a and 173b.

A lower passivation layer 180p preferably made of silicon nitride or silicon oxide is formed on the data lines 171a and 171b, the drain electrodes 175a and 175b, and the exposed portions of the semiconductors 154a and 154b.

Referring to FIG. 4, the partition 361 is formed according to the gate lines 121 and the data lines 171a and 171b. A region enclosed by the partition 361 substantially forms a rectangle as a filling region where a color filter 230 is filled. Again referring to FIGS. 2 and 3, the color filter 230 is filled in the filling region. Here, the lower passivation layer 180p prevents the pigment of the color filter 230 from flowing to the exposed semiconductors 154a and 154b.

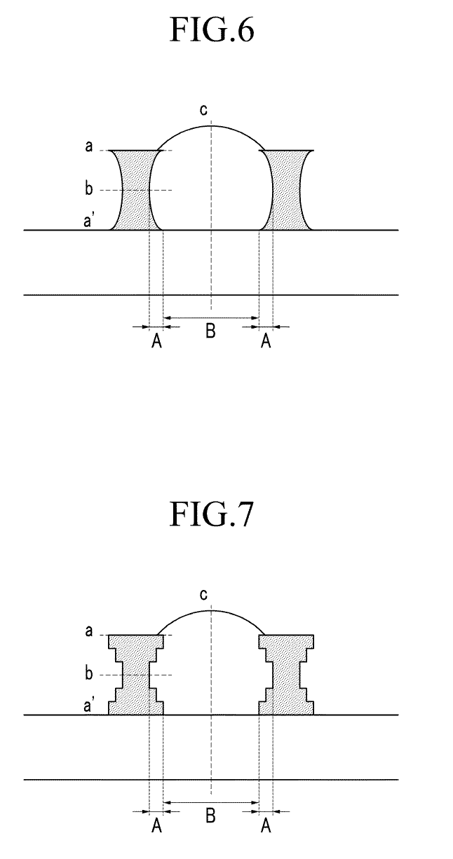

A partition 361 is formed on the lower passivation layer 180p. The partition 361 includes a light blocking insulating material that absorbs light and is black, thereby having the function as a light blocking member. As shown in FIG. 6, a partition 361 is formed as length of upper portion (a) and lower portion (a′) on cross sectional view are larger than that of center portion (b), decreased gradually to the center portion (b) from the both end portion.

Referencing FIG. 6, color filter may have a dome shape by the tetragonally shaped partition generating light leakage at the edge of pixel areas. However, length of upper or lower portion (B) is shorter than that of center portion by the difference (A) on cross sectional view of the color filter phase retardation of penetrating light on dome shaped color filter area can be compensated by convex shaped color filter area at the edge of pixel area.

Another exemplary pardon shape is shown in FIG. 7. The length of upper is portion (a) and lower portion (a′) are larger than that of center portion (b), decreased stepwise to the center portion (b) from the both end portion.

An upper passivation layer 180q is formed on the partition 361 and the color filter 230. The upper passivation layer 180q may be made of an organic material having photosensitivity. Also, the upper passivation layer 180q preferably has a thickness of more than 1.0 μm to reduce the coupling effect between the pixel electrode 191 and the data lines 171a and 171b and to planerize the substrate.

The upper passivation layer 180q, the color filter 230, and the lower passivation layer 180p have a plurality of contact holes 185a and 185b exposing the first and second drain electrodes 175a and 175b. The contact holes 185a and 185b are simultaneously formed in the upper passivation layer 180q, the color filter 230, and the lower passivation layer 180p such that the boundaries forming the contact holes 185a and 185b in the upper passivation layer 180q, the color filter 230, and the lower passivation layer 180p have substantially the same plane shape.

In an exemplary embodiment of the present invention, as shown in FIG. 4, the partition 361 is only disposed on the gate lines 121 and the data lines 171a and 171b such that the partition 361 substantially forms a quadrangle and is not presented in the pixel, thereby minimizing the area occupied with the partition 361 and increasing the aperture ratio.

A plurality of pixel electrodes 191 are formed on the upper passivation layer 180q. As shown in FIG. 5, each pixel electrode 191 includes the first and second subpixel electrodes 191a and 191b that are separated from each other with a gap 91 of a quadrangular belt shape therebetween, and the first and second subpixel electrodes 191a and 191b respectively include a basic electrode 199 as shown in FIG. 7, or at least one modification thereof.

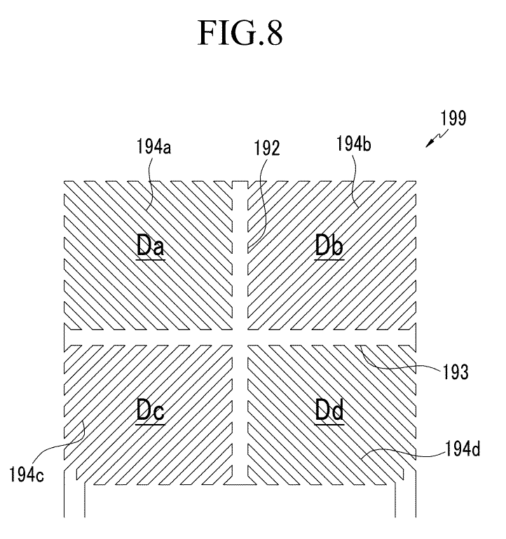

Next, the basic electrode 199 will be described in detail with reference to FIG. 8. As shown in FIG. 8, the overall shape of the basic electrode 199 is a quadrangle, and it includes a cross-shaped stem having a transverse stem 193 and a longitudinal stem 192 that are crossed. Also, the basic electrode 199 is divided into a first sub-region Da, a second sub-region Db, a third sub-region Dc, and a fourth sub-region Dd by the transverse stem 193 and the longitudinal stem 192, and each of the sub-regions Da-Dd include a plurality of first to fourth minute branches 194a, 194b, 194c, and 194d.

The first minute branch 194a obliquely extends from the transverse stem 193 or the longitudinal stem 192 in the upper-left direction, and the second minute branch 194b obliquely extends from the transverse stem 193 or the longitudinal stem 192 in the upper-right direction. Also, the third minute branch 194c obliquely extends from the transverse stem 193 or the longitudinal stem 192 in the lower-left direction, and the fourth minute branch 194d obliquely extends from the transverse stem 193 or the longitudinal stem 192 in the lower-right direction. The first to fourth minute branches 194a-194d form an angle of about 45 degrees or 135 degrees with the gate lines 121 or the transverse stem 193. Also, the minute branches 194a-194d of two neighboring sub-regions Da-Dd may be crossed. Although not shown, the width of the minute branches 194a-194d may become wider close to the transverse stem 193 or the longitudinal stem 192.

Again referring to FIG. 2 to FIG. 5, the first and second subpixel electrodes 191a and 191b include one basic electrode 199. However, the area occupied by the second subpixel electrode 191b may be larger than the area occupied by the first subpixel electrode 191a in the whole pixel electrode 191, and here, the basic electrodes 199 may be formed differently from each other to have the area of the second subpixel electrode 191b have 1.0 to 2.2 times the area of the first subpixel electrode 191a.

Each first/second subpixel electrode 191a/191b is physically and electrically connected to the first/second drain electrode 175a/175b through the contact hole 185a/185b, and receive data voltages from the first/second drain electrode 175a/175b.

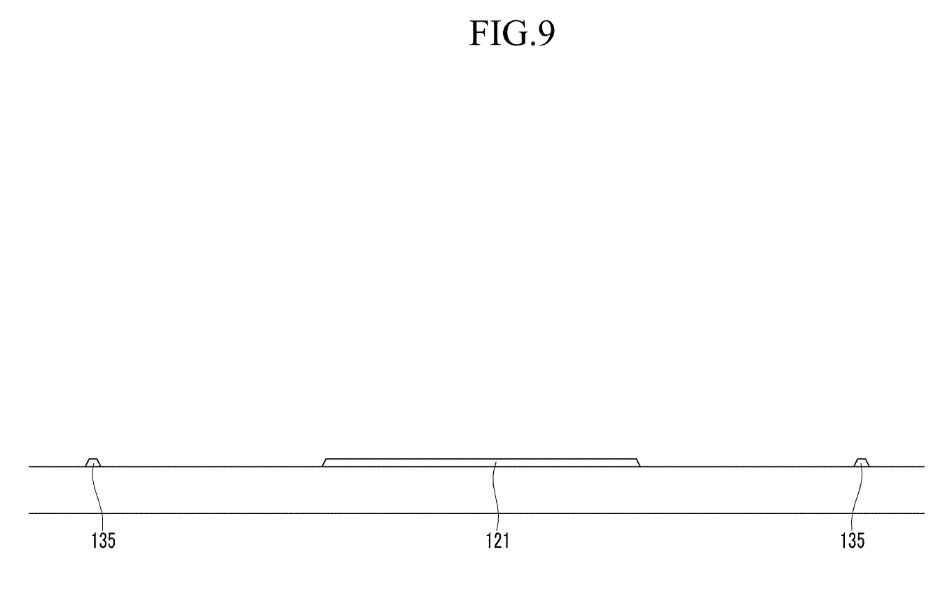

A manufacturing method of a thin film transistor with color filter array panel for the above-described liquid crystal display will now be described with reference to FIGS. 9 to 14.

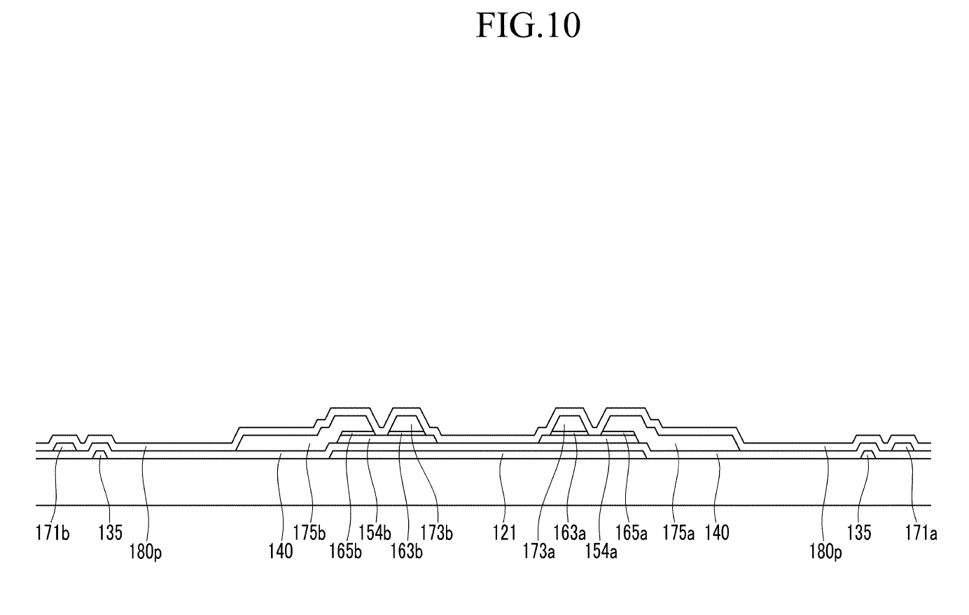

FIGS. 9 to 14 are cross-sectional views sequentially showing a manufacturing method of a thin film transistor with color filter array panel for the liquid crystal display shown in FIG. 2 and FIG. 3. As shown in FIG. 9, a gate line 121 including storage line 135 is formed on an insulation substrate 110. Next, as shown in FIG. 10, a gate insulating layer, an amorphous silicon layer that is doped with an impurity, an amorphous silicon layer that is doped with an impurity, and a data conductive layer are sequentially deposited on the substrate 110 including the gate line 121.

Next, a photosensitive film (not shown) is coated on the data conductive layer, and is exposed and developed by using a slit mask to form a photoresist pattern having different thickness depending on position. Next, the data conductive layer, the doped amorphous silicon layer, and the non-doped amorphous silicon layer are firstly etched by using the photoresist pattern as a mask to form semiconductors 154a and 154b, and the data conductive layer is secondly etched to form data lines 171a and 171b including source electrodes 173a and 173b and drain electrodes 175a and 175b. Next, the exposed amorphous silicon layer is etched by using the source electrodes 173a and 173b and the drain electrode 175a and 175b as an etch mask to form ohmic contact layers 161a, 161b, 163a, 163b, 165a, and 165b as shown in FIG. 10. A lower passivation layer 180p is formed on the data lines 171a and 171b and the drain electrodes 175a and 175b.

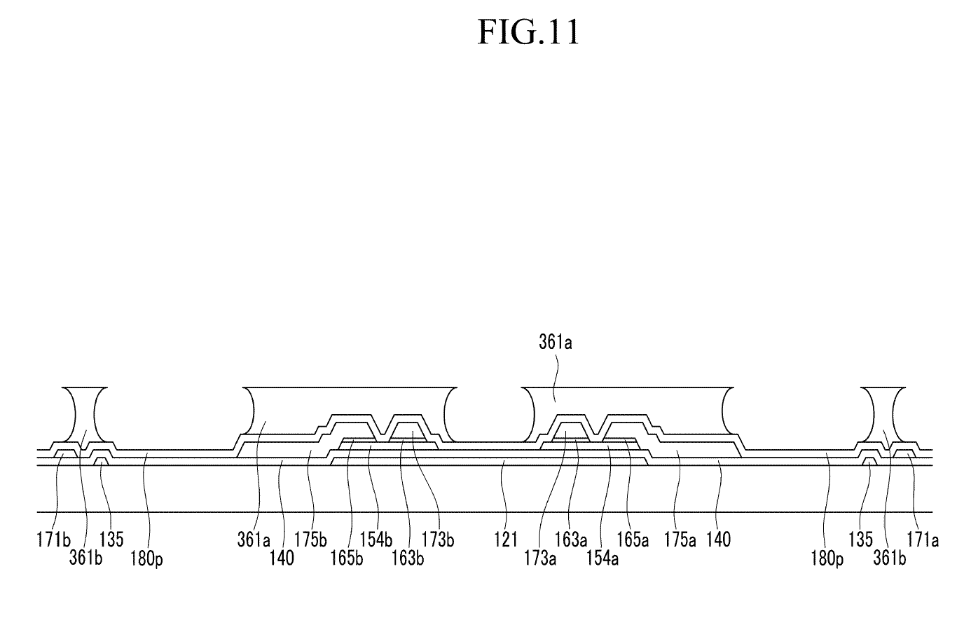

As shown in FIG. 11, a black organic material is formed on the lower passivation layer 180p, and is patterned to form a partition 361. The partition 361 of the present invention is formed according to the gate line 121 and the data lines 171a and 171b such that the region where the color filter 230 is filled forms a convex space.

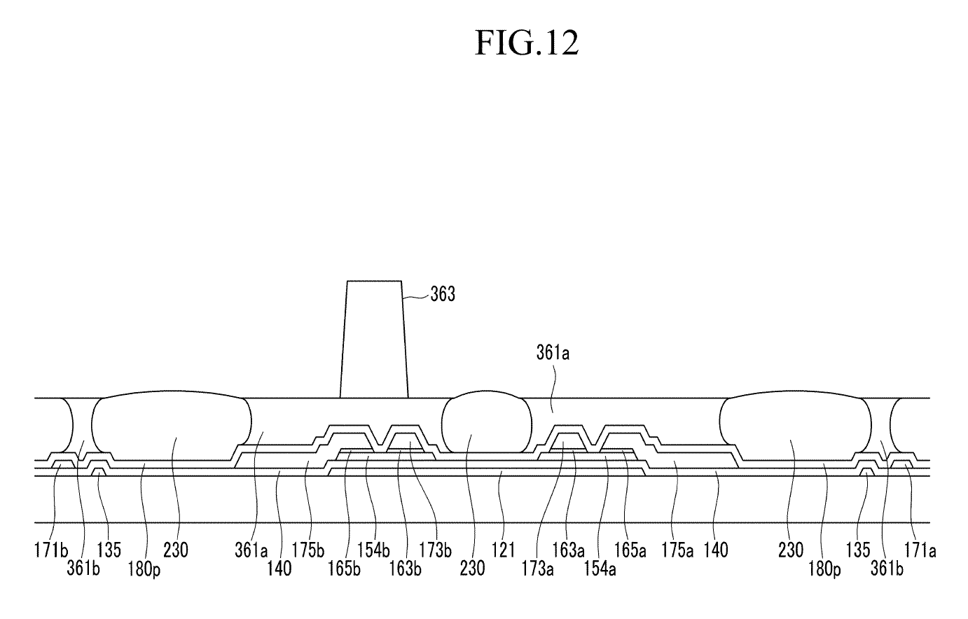

Next, a color filter 230 is formed in a pixel defined by the partition 361 as shown in FIG. 12. The color filter 230 may be formed by an Inkjet printing method, wherein an Inkjet head drips a color filter solvent while being moved, and the color filter solvent is then dried. Spacers 363 may be formed on the opaque black organic material, sustaining the cell gap between a lower panel 100 and an upper panel 200 facing each other, and a liquid crystal layer 3 interposed therebetween.

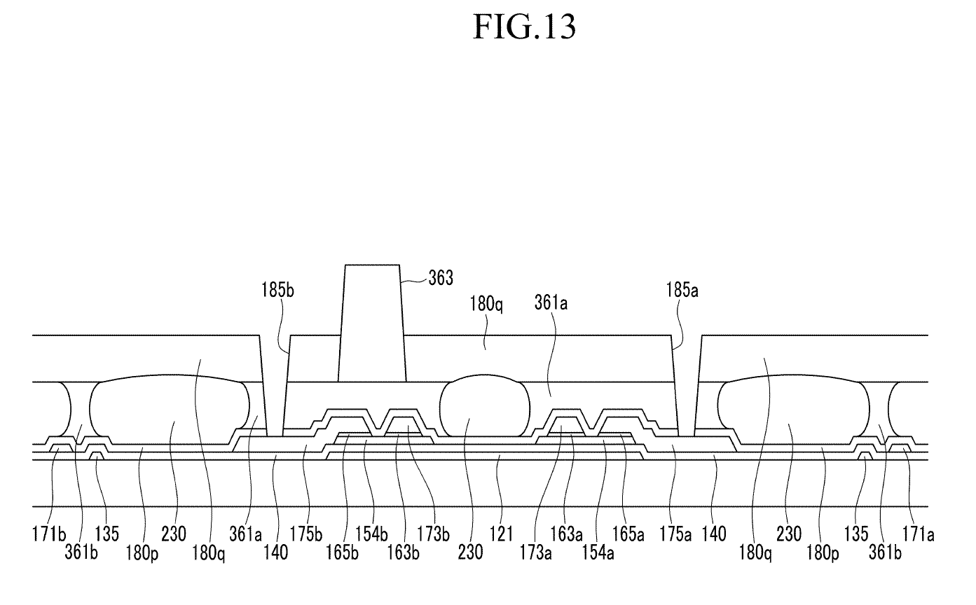

As shown in FIG. 13, an upper passivation layer 180q is formed on the color filter 230 and the partition 361, and is patterned along with the color filter 230 and the lower passivation layer 180p to form contact holes 185a and 185b. Here, when forming the upper passivation layer 180q made of a photosensitive organic material, the upper passivation layer 180q is exposed and developed, and the color filter 230 and the lower passivation layer 180p are dry-etched. The upper passivation layer 180q, the color filter 230, and the lower passivation layer 180p are etched together such that the inner boundaries of the contact holes 185a and 185b formed in the upper passivation layer 180q, the color filter 230, and the lower passivation layer 180p have substantially the same plane pattern and accord with each other.

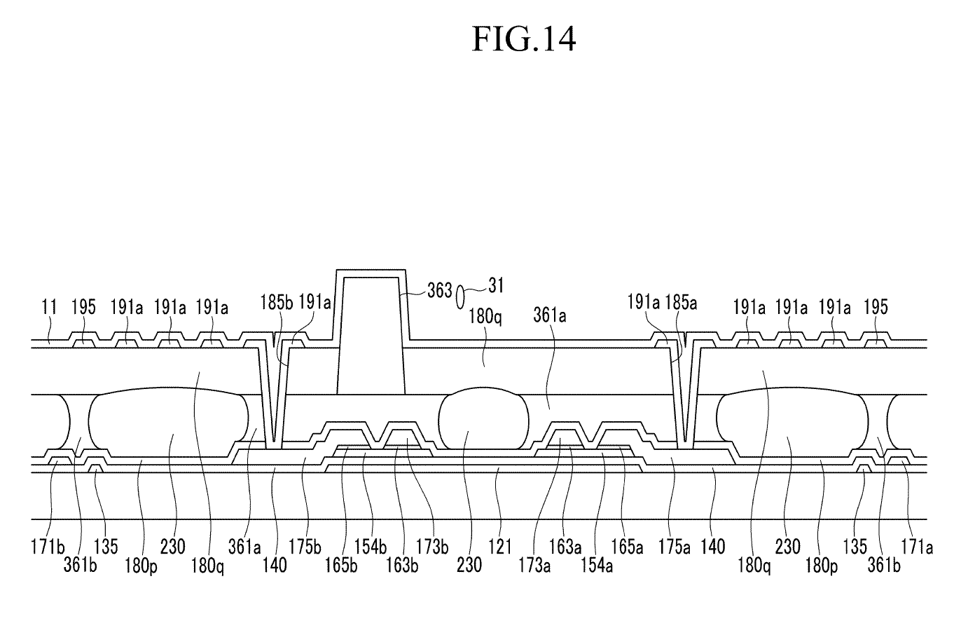

Pixel electrode including 191a and 191b is formed on the upper passivation layer 180q as shown in FIG. 14. Alignment layer 1 of liquid crystal molecule 31 is formed on the pixel electrode as alignment layer 21 on the common electrode 270 of an upper panel 200.

What is claimed is:

1. A display panel comprising:
a first insulating substrate;
a gate line and a data line formed on the insulating substrate and insulated from and intersecting each other;
a thin film transistor connected to the gate line and the data line;
a partition formed according to the gate line and the data line;
a color filter formed in the filling region defined by the partition;
a passivation layer formed on the color filter and the partition; and
a pixel electrode formed on the passivation layer and connected to the thin film transistor through a contact hole formed in the passivation layer and the color filter,
wherein both circumferences of upper portion and lower portion of the partition are larger than that of center portion

2. A display panel of claim 1, wherein the color filter is formed on the first insulating substrate

3. A display panel of claim 1, wherein the partition is formed on the first insulating substrate

4. A display panel of claim 1,
a second insulating substrate facing to the first insulating substrate
a liquid crystal layer interposed therebetween
a spacer between the first and the second substrate
wherein the spacer is formed with the partition in the same process step

5. A display panel of claim 1,
an upper passivation layer formed on the color filter
a pixel electrode formed on the upper passivation
wherein the upper passivation layer is formed to the thickness higher than the highest position of the color filter

6. A display panel of claim 1, wherein
a lower passivation layer is formed on the thin film transistor and the gate line

7. A display panel comprising:
a first insulating substrate;
a gate line and a data line formed on the insulating substrate and insulated from and intersecting each other;
a thin film transistor connected to the gate line and the data line;
a second insulating substrate;
a partition formed on the second insulating substrate;
a color filter formed in the filling region defined by the partition;
wherein both circumferences of upper portion and lower portion of the partition are larger than that of center portion

8. A display panel of claim 7,
a second insulating substrate facing to the first insulating substrate
a liquid crystal layer interposed therebetween
a spacer between the first and the second substrate
wherein the spacer is formed with the partition in the same process step

9. A manufacturing method of display panel, comprising:
forming a gate line including a gate electrode on a substrate;
forming a gate insulating layer on the gate line;
forming a semiconductor and an ohmic contact layer on the gate insulating layer;
forming a data line including a source electrode and a drain electrode on the ohmic contact layer;
forming a lower passivation layer on the data line and the drain electrode;
forming a partition with a sandglass shape according to the gate line and the data line on the lower passivation layer;
forming a color filter in a filling region defined by the partition;
forming an upper passivation layer on the color filter;
simultaneously etching the upper passivation layer and the color filter to form a contact hole exposing the drain electrode; and
forming a pixel electrode connected to the drain electrode through the contact hole on is the upper passivation layer.
